(19) United States
(12) Patent Application Publication
(10) Pub. No.: US 2005/0208649 A1
(43) Pub. Date: Sep. 22, 2005

(54) Container for transporting biological material

(76) Inventor: Oliver Ringleb, Frieburg (DE)

Correspondence Address: RATNERPRESTIA, P O BOX 980, VALLEY FORGE, PA, 19482-0980, US

(21) Appl. No.: 10/512,913

(22) PCT Filed: Apr. 30, 2003
(86) PCT No.: PCT/EP03/04561

§ 371 Date: May 18, 2005

(30) Foreign Application Priority Data
Apr. 30, 2002 (DE) 102 19 312.6

(51) Int. Cl. A01N 1/02

(52) U.S. Cl. 435/307.1; 435/284.1

(57) ABSTRACT

A container for transporting a biological material and the use of the container are contemplated. The container includes a self-supporting container having a stable shape. Disposed with in the container is an insulating material in which a reversibly sealed Dewar vessel is maintained. Within the Dewar vessel is either a heat or cold unit to maintain the temperature within the Dewar vessel thereby maintaining the temperature of the biological material contained therein.

The present invention concerns a transport container for biological material and its use to transport such material.

Biological material is very temperature-sensitive, especially when it involves viable mammalian cells or organs. Inside the mammalian organism, a constant temperature is ensured by the body's own temperature homeostasis. Outside the organism, the cells also rely on a constant temperature of this kind without themselves being able to ensure temperature equilibrium.

The body temperature of most mammals including humans is above 30° C. In the case of humans it is mostly ±37° C. The metabolism of the mammalian cell is adapted to this temperature in such a way that most of the cell's enzymes show an optimum in this range. If the temperature differs markedly from this optimum, the first thing that happens in most cases is damage to the cells, and in extreme cases cell death. Conservation procedures at the present time are normally based on using cold to slow down the metabolism, for example by cooling or freezing. This involves a great danger of cell damage.

The sensitivity of mammalian cells to temperature fluctuations constitutes a serious problem, especially in transplantation medicine, since in this case cells and/or organs that are to be transplanted need to be transported from the donor to the recipient, and during this time they must be maintained as far as possible in an optimum condition to avoid tissue necroses etc.

At the present time, cells and/or organs that are to be transplanted, i.e. the transplants, are usually transported in special containers, frozen in liquid nitrogen at −70° C. and/or on ice, i.e. at about 0° C. to −20° C. Although this treatment ensures the viability of the majority of the cells, it tacitly accepts the death of a certain proportion of them.

Therefore the task of the present invention is a transport container for biological material, in particular for material that is to be transplanted, that enables the cells to be transported at a temperature that is constant within a pre-determined range, thus preserving the viability of the cells during transport.

The task according to the invention is solved by a transport container for biological material, especially for mammalian cell material that is to be transplanted, comprising in this sequence from the outside to the inside:
a self-supporting container with a stable (=rigid) shape,
an insulating material in the container,
a reversibly sealable Dewar vessel in the insulating material, and
optionally a manipulator,
together with at least one heat and/or coldness unit in the Dewar vessel.

Advantageously, the transport container according to the invention has both means to maintain the temperature, such as the Dewar vessel and the insulating material, and also means to store coldness and/or heat, such as the at least one heat and/or coldness unit. By this means it is possible firstly to delay markedly the equalisation of the temperature with the ambient temperature. Secondly it is possible to re-supply and/or absorb energy in an appropriate way from the heat and/or coldness unit when the input or removal of heat commences precisely because of this equalisation, which further delays the temperature equalisation process. Moreover, the use of a reversibly sealable Dewar vessel ensures the sterile handling of the material, independent of the external insulation.

Finally, the use of two insulating systems, i.e. Dewar and insulating material, also permits the use of the shock-absorbing properties of the insulating material. In the transport container according to the invention, the first insulating system, the Dewar vessel, is thus also protected advantageously against damage during transport. In combination with a self-supporting container of stable shape (rigid), the insulating material can essentially prevent any mechanical damage to the Dewar vessel, material container and material under the usual conditions of transport. At the same time the external rigid container enables easy handling of the biological material during transport, even by inexperienced personnel, e.g. a courier service.

As described above, the transport container according to the invention comprises, as the external element, a self-supporting container of stable shape (rigid). Basically this can have any suitable shape, but will usually represent a cuboid, a cylinder or a box. The self-supporting, rigid container can be made of any suitable material. Usually the self-supporting, rigid container is made from cardboard, paperboard, plastic or metal, as well as mixtures thereof.

The insulating material represents the second layer of the transport container according to the invention. The Dewar vessel is embedded in the insulating material. Usually the insulating material is present in a quantity such that it fills up essentially the entire space between the Dewar vessel and the inner wall of the self-supporting, rigid container. Preferably the insulating material surrounds the Dewar vessel on all sides thereof, preferably uniformly, in order to ensure the most uniform possible insulation.

The insulating material that is used can involve any material that has adequate insulating properties, i.e. a sufficiently small thermal conductivity. Natural insulating materials such as cotton, wood shavings, cellulose etc., or synthetic insulating materials can be used. The latter are preferred because of their availability and their easier sterile handling. Therefore, especially preferably, the insulating material consists of a material chosen from among polyurethane, polystyrene such as Styropor®, polycarbonate, copolymers containing these and their mixtures.

In accordance with its description, the Dewar vessel used according to the invention is a double-walled, mirror-coated glass or stainless steel vessel with a vacuum or reduced pressure present between the walls. The Dewar vessel is reversibly sealable in the sense that it can be opened and closed repeatedly without destroying the closure mechanism. For example this can take the form of a screw mechanism or a clip mechanism.

Preferably the Dewar vessel and lid are capable of being sterilised. This avoids contamination of the biological material during transport. Preferably the Dewar vessel is a commercially available Thermos® jar, obtainable for example from the Hintz Company, Wiesbaden, Germany.

Finally, the transport container according to the invention comprises at least one and preferably two heat and/or coldness unit(s). A heat and/or coldness unit means any suitable device for storing heat and coldness respectively. The only essential feature is the ability to absorb heat and coldness respectively and to release them to their surroundings when necessary.

The at least one unit is preferably flexible to avoid damaging the Dewar vessel. Moreover, its size is preferably dimensioned in such a way that the internal volume of the Dewar vessel is filled up completely when using the required number of units with the biological material. Thus preferably the unit(s) simultaneously protect the Dewar vessel from damage caused by the container of biological material impacting against the inner wall.

Most preferably, the heat and/or coldness unit involves a unit comprising a flexible sheath filled with a heat transfer fluid. For example sheaths made from elastomers such as polyethylene or polypropylene are suitable. These (sheaths) are usually filled with suitable heat transfer fluids and optionally solid constituents such as sponges etc. A particularly suitable unit is marketed by the Laminar Medica Ltd. Company, Hertfordshire, UK, under the name “Medicool MC-20” or “Medicool MC-11”.

The at least one heat and/or coldness unit is arranged in the Dewar vessel. During transport, the biological material is arranged in a container that is suitable for it, usually close to the unit. Preferably the container with the biological material is in immediate contact with the unit(s). When using two units, it is preferable in most cases for the biological material to be situated “sandwich-wise” between the two units. In this respect the biological material can be arranged either horizontally or vertically relative to the walls of the Dewar.

The transport container according to the invention, as defined above, can additionally contain a biological material in the Dewar vessel. This biological material is preferably contained in a sealable container, preferably a syringe, a bag, a vial etc. Any container that is normally used is suitable, provided it effectively protects the material against contact with its surroundings. Optionally the container can have an additional packing around it.

Basically the biological material that is to be transported according to the invention and accordingly contained in the transport vessel can be any desired biological material. However, preferably it involves viable cells, particularly preferably viable mammalian cells including human cells, since these benefit most from the temperature constancy.

In concrete terms, the biological material can involve a cell suspension, a tissue, material colonised with cells or an organ. Preferably these materials are intended for transplantation into a host, including human beings. Particularly preferably, the biological material is a cell suspension, for example of chondrocytes, periosteal cells, melanocytes, keratinocytes etc. in a suitable medium.

In one embodiment, the reversibly sealable container for the biological material can additionally contain a second material, optionally in an additional compartment. This can involve, for example, an auxiliary solution for the transplantation. One example of such an auxiliary solution would be a solution containing fibrinogen, whereby the container contains a suspension of melanocytes or periosteal cells in combination with thrombin as the first solution.

Finally, the transport container according to the invention can contain a manipulator such as an insertion aid, a forceps etc., which is embedded in the insulating material alongside the Dewar vessel or is arranged in a self-supporting container alongside the latter.

In a second aspect, the invention concerns the use of a transport container as defined above to transport and/or to store a biological material containing viable cells. This biological material is preferably intended for transplantation into a mammal, including human beings.

In the use of the transport container according to the invention, the internal temperature thereof and thus the temperature of the biological material during transport can be maintained within a pre-determined range. For this purpose the at least one unit and the biological material are brought to the selected temperature, for example between 0 and 38° C., preferably 2 to 35° C., and are put into the Dewar vessel, which is then sealed and introduced into the self-supporting, rigid container equipped with insulating material. Preferably the temperature range is between 10 and 25° C., most preferably between 10 and 20° C.

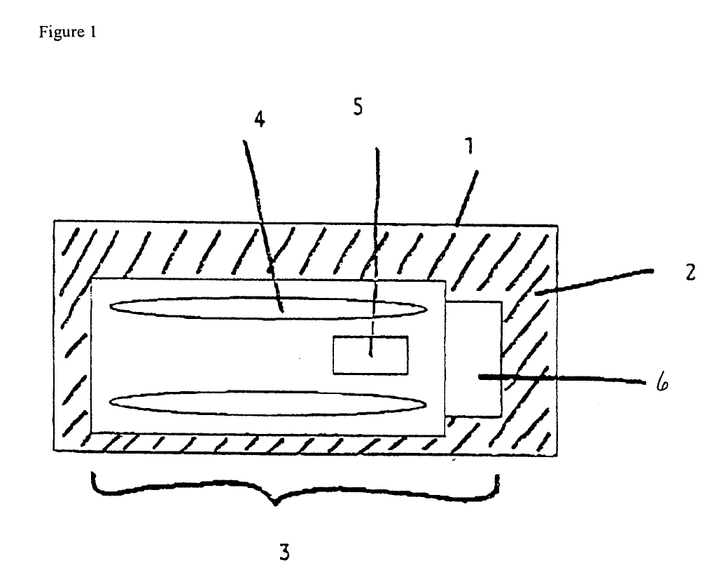

FIG. 1 shows a preferred embodiment of the transport container for biological material according to the invention. The transport container comprises a self-supporting, box-shaped container made of paperboard, 1. This is lined with a polyurethane insulating material 2. Embedded in the insulating material 2 there is a Thermos® jar 3 that can be sealed with a screw lid 3a. Situated in the jar 3 there are two Medicool coldness units 4. A vial or a syringe 5 with the biological material is arranged between the latter.

Tests with a transport container arranged in this way have shown that no significant temperature fluctuations are detectable in the interior of the Dewar vessel during a period of up to 48 hours. At the same time the material was protected against damage in transit. The transport container was tested using thermal sensors, temperature measurements being made at regular intervals. Tests took place under controlled laboratory conditions and also in actual dispatch via a courier service. The results confirm that temperature constancy for the biological material can be guaranteed by the use of the transport container according to the invention.

1. A transport container for biological material comprising in this sequence from the outside to the inside:
a self-supporting container with a stable shape;
an insulating material disposed within the containers;
a reversibly sealable Dewar vessel in the insulating material; and
at least one of a heat or coldness unit disposed in the Dewar vessel.

2. The transport container according to claim 1, wherein the self-supporting container is made from a material selected from the group consisting of cardboard, paperboard, plastic or metal.

3. The transport container according to claim 1, wherein the insulating material is present in a quantity such that it fills up essentially the entire space between the Dewar vessel and the inner wall of the self-supporting container.

4. The transport container according to claim 1, wherein the insulating material is selected from the group consisting of polyurethane, polystyrene, polycarbonate and mixtures thereof.

5. The transport container according to claim 1, wherein the Dewar vessel is a commercially available vessel sold under the trademark Thermos®.

6. The transport container according to claim 1, wherein at least one of the heat or coldness unit comprises a flexible sheath filled with a heat transfer fluid.

7. The transport container according to claim 1, containing two heat or coldness units.

8. The transport container according to claim 1, wherein the Dewar vessel maintains a biological material.

9. The transport container according to claim 8, wherein the biological material is accommodated in a sealable container.

10. The transport container according to claim 1, wherein the biological material comprises viable cells.

11. The transport container according to claim 1, wherein the biological material comprises one of a cell suspension, a tissue, a material colonised with cells, or an organ.

12. The transport container according to claim 1, wherein the reversibly sealable container additionally contains a second material.

13. A method for transporting biological materials comprising the steps of:
providing a self-supporting container with a stable shape;
placing a biological material containing viable cells into a Dewar vessel;
placing the Dewar vessel in the self-supporting container; and
disposing insulating material between the Dewar vessel and an inside wall of the self-supporting vessel.

14. The method according to claim 13, wherein the biological material is intended for transplantation into a mammal including humans.

15. The method of claim 13, further comprising maintaining the temperature of the biological material within a pre-determined range during transport.

16. The method of claim 15, wherein the temperature is in a range of from about 10 to about 20° C.

17. The transport container according to claim 1 further comprising a manipulator disposed within the Dewar vessel.

18. The transport container according to claim 9, wherein the sealable container is a syringe.

19. The transport container according to claim 12, wherein the sealable container further comprises an additional compartment for securing the second material.
